(19) United States
(12) Patent Application Publication
(10) Pub. No.: US 2020/0110005 A1
(43) Pub. Date: Apr. 9, 2020

(54) REAL-TIME PERFORMANCE MONITORING AND PREDICTIVE MAINTENANCE SYSTEM

(71) Applicant: FORUM US, INC., Houston, TX (US)

(72) Inventors: Ryan S. WILLIAMS, Houston, TX (US); Bao Q. TRUONG, Cypress, TX (US)

(21) Appl. No.: 16/153,981

(22) Filed: Oct. 8, 2018

(51) Int. Cl. G01M 99/00; G01M 5/00

(52) U.S. Cl. CPC G01M 99/005; E21B 19/155; G01M 5/0033

(57) ABSTRACT

A system configured to monitor structural health of one or more pieces of equipment in real time. The system comprises a piece of equipment, a plurality of operating sensors coupled to the piece of equipment and configured to measure operational data regarding the piece of equipment, and an onboard processing transceiver in communication with the operating sensors. The onboard processing transceiver comprises a processor having a first processing device, a second processing device, and a third processing device configured to calculate structural health of the piece of equipment based on operational data.

### BACKGROUND

### Field

Embodiments of this disclosure relate to systems and methods for monitoring in real time the structural health of one or more pieces of equipment.

### Description of the Related Art

Drilling equipment, such as catwalks, elevators, mud pumps, frac pumps, top drives, draw works, etc. are often operated beyond their operating specifications. The equipment is designed for a specific use at specific operating conditions, so when the equipment is consistently operated above the operating conditions, the equipment needs more frequent maintenance, which increases the cost of ownership. In some cases, consistently operating the equipment above the operating conditions can lead to premature failure of the equipment, which can pose a safety risk to nearby workers.

Therefore there is a need for new and improved systems and methods for monitoring the structural health of one or more pieces of equipment.

### SUMMARY

In one embodiment, a system for monitoring structural health of a piece of equipment in real time comprises a piece of equipment; one or more operating sensors coupled to the piece of equipment, wherein the operating sensors are configured to measure operational data of the piece of equipment during operation; and an onboard processing transceiver coupled to the piece of equipment and in communication with the operating sensors, wherein the onboard processing transceiver is configured to determine structural health of the piece of equipment.

In one embodiment, a method for monitoring structural health of a piece of equipment in real time comprises receiving operational data from one or more operating sensors that are coupled to the piece of equipment; calculating stress data based on the operational data; calculating fatigue data and/or cumulative damage data based on the stress data; and calculating structural health based on the fatigue data and/or cumulative damage data to determine remaining operating life of the piece of equipment.

### BRIEF DESCRIPTION OF THE DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic diagram of one embodiment of a real-time performance monitoring and predictive maintenance system for determining the structural health of a piece of equipment in real time.

FIG. 2 illustrates a catwalk next to a rig depicting one embodiment of a real-time performance monitoring and predictive maintenance system.

FIGS. 3A and 3B illustrate sectional views of a pump system at different operating positions depicting one embodiment of the real-time performance monitoring and predictive maintenance system.

FIG. 4 is a flow chart depicting one embodiment of a method for monitoring structural health of a piece of equipment using the real-time performance monitoring and predictive maintenance system.

FIG. 5A is a graph illustrating a stress-strain curve of a material of a piece of equipment.

FIG. 5B is a graph illustrating an endurance limit of a material of a piece of equipment.

FIG. 6 is a graph illustrating structural health of a piece of equipment over time as calculated by the real-time performance monitoring and predictive maintenance system.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein relate to a real-time performance monitoring and predictive maintenance system configured to determine structural health of one or more pieces of equipment, such as drilling equipment used in the oil and gas industry. The real-time performance monitoring and predictive maintenance system includes one or more operating sensors configured to monitor the operating conditions of a piece of equipment in real time. The piece of equipment includes the entire piece equipment, a portion of the equipment, or a component of the equipment.

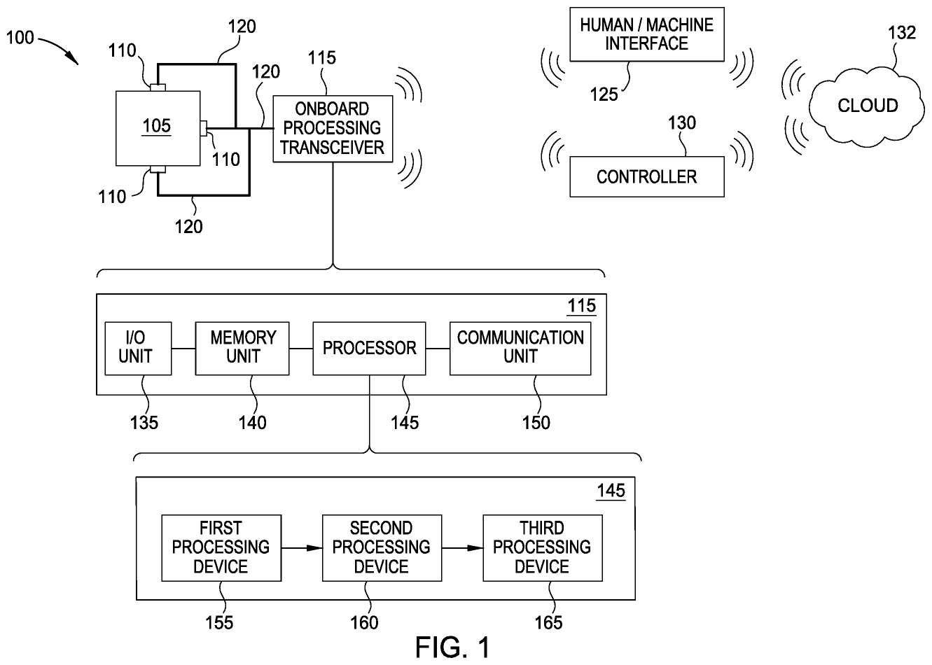

FIG. 1 is a schematic diagram of one embodiment of a real-time performance monitoring and predictive maintenance system 100 configured to determine the structural health of a piece of equipment 105. The piece of equipment 105 may be a mud pump, a frac pump, a catwalk, an elevator, a top drive, a draw works, and/or other types of pumps and/or tubular handling tools. One or more operating sensors 110 are coupled to the piece of equipment 105.

The operating sensors 110 are configured to gather operational data relating to the operation of the piece of equipment 105. The operational data includes operational history, loading conditions, and/or boundary conditions.

Operational history includes, but is not limited to, information on cycles of the equipment (e.g., number of cycles and/or weight per cycle) and/or operational hours of the equipment. Loading conditions include, but is not limited to, load, weight, stress, pressure, vibration, temperature, current, and/or voltage. Boundary conditions include, but are not limited to, orientation data, position data, and/or angle data.

The operational data gathered by the operating sensors 110 is communicated to an onboard processing transceiver 115 via a wired connection 120. The onboard processing transceiver 115 is coupled (directly or indirectly) to the piece of equipment 105, and is dedicated to the piece of equipment 105 such that the onboard processing transceiver 115 travels with the piece of equipment 105 from one location to the next. The onboard processing transceiver 115 may be paired with a particular piece of equipment 105 for the operational lifetime of the piece of equipment 105.

The operational data transmitted to the onboard processing transceiver 115 from the operating sensors 110 via the wired connection 120 may be at a first frequency, such as about 60,000 data points per second. The operational data is processed by the onboard processing transceiver 115 to calculate performance data as further described below. The onboard processing transceiver 115 is configured to transmit the performance data to a human/machine interface 125, a controller 130, and/or a cloud based system 132 at a second frequency, such as about 120 data points per second, that is lower than the first frequency.

The onboard processing transceiver 115 includes an input/output unit 135, a memory unit 140, a processor 145, and a communication unit 150. The input/output unit 135 is configured to receive and/or retrieve the operational data from the operating sensors 110. The operational data can be stored in the memory unit 140 and communicated to the processor 145, which is configured to calculate the performance data based on the operational data. The performance data can be stored in the memory unit 140, and communicated to the human/machine interface 125, the controller 130, and/or the cloud based system 132 wirelessly via the communication unit 150

The processor 145 includes a first processing device 155, a second processing device 160, and a third processing device 165. Each of the first processing device 155, the second processing device 160, and the third processing device 165 may include software containing an algorithm configured to perform the calculations described herein.

The first processing device 155 calculates stress of the piece of equipment 105 based on the operational data (such as loading conditions and boundary conditions) and outputs stress data. The stress data is communicated to the second processing device 160.

The second processing device 160 calculates fatigue and/or cumulative damage of the piece of equipment 105 based on the stress data (such as by comparing a stress range over time) and outputs fatigue data and/or cumulative damage data. The fatigue data and/or cumulative damage data is communicated to the third processing device 165.

The third processing device 165 calculates structural health of the piece of equipment 105 based on the fatigue data and/or cumulative damage data (such as by comparing the fatigue data and/or cumulative damage data to fatigue data and/or cumulative damage data based on traditional stress models) and outputs structural health data.

The stress data, the fatigue data and/or cumulative damage data, the structural health data, and/or any other operational data received by the onboard processing transceiver 115 is communicated to the human/machine interface 125, the controller 130, and/or the cloud based system 132 in the form of performance data. The performance data is transmitted wirelessly to and logged by the human/machine interface 125, the controller 130, and/or the cloud based system 132, any of which can be configured to control the operation of the piece of equipment 105 based at least in part on the performance data.

The human/machine interface 125 can be a display device where an operator can view the performance data, such as a personal computer, a screen coupled to the piece of equipment 105, and/or a cellular phone. The controller 130 can be a control device having a central processing unit and/or any other control mechanisms configured to receive and process the performance data, as well as control the operation of the piece of equipment 105. The cloud based system 132 can be a remote server accessible via the internet.

The human/machine interface 125, the controller 130, and/or the cloud based system 132 are configured to communicate with each other via wired and/or wireless communication to control the operation of the piece of equipment 105 based at least in part on the performance data.

In one example, an operator can view the performance data on the human/machine interface 125 (as received from the onboard processing transceiver 115 and/or retrieved from the cloud based system 132) and then in response instruct the controller 130 to start, stop, and/or adjust the operation of the piece of equipment 105. In one example, the controller 130 can automatically start, stop, and/or adjust the operation of the piece of equipment 105 based at least in part on the performance data (as received from the onboard processing transceiver 115 and/or retrieved from the cloud based system 132) and then inform the operator via the human/machine interface 125. In one example, the cloud based system 132 can automatically start, stop, and/or adjust the operation of the piece of equipment 105 (directly or via the controller 130) based at least in part on the performance data and then inform the operator via the human/machine interface 125.

The human/machine interface 125, the controller 130, and/or the cloud based system 132 are configured to calculate and/or log the operational history of the piece of equipment 105 based on the performance data. The operational history can be obtained directly from one or more of the operating sensors 110, which data is passed through the onboard processing transceiver 115 as part of the performance data for processing and/or logging by the human/machine interface 125, the controller 130, and/or the cloud based system 132.

The operational data is communicated on a continuous or as-needed basis to the onboard processing transceiver 115 in real time or near real time such that the performance data, e.g. the stress, fatigue and/or cumulative damage, structural health, and/or any other operational data of the piece of equipment 105 is known on a real time basis. Based on the performance data (structural health data for example), the real-time performance monitoring and predictive maintenance system 100 can predict the remaining operating life of the piece of equipment 105, identify operating trends, as well as optimal service intervals to optimize the operating life of the equipment 105.

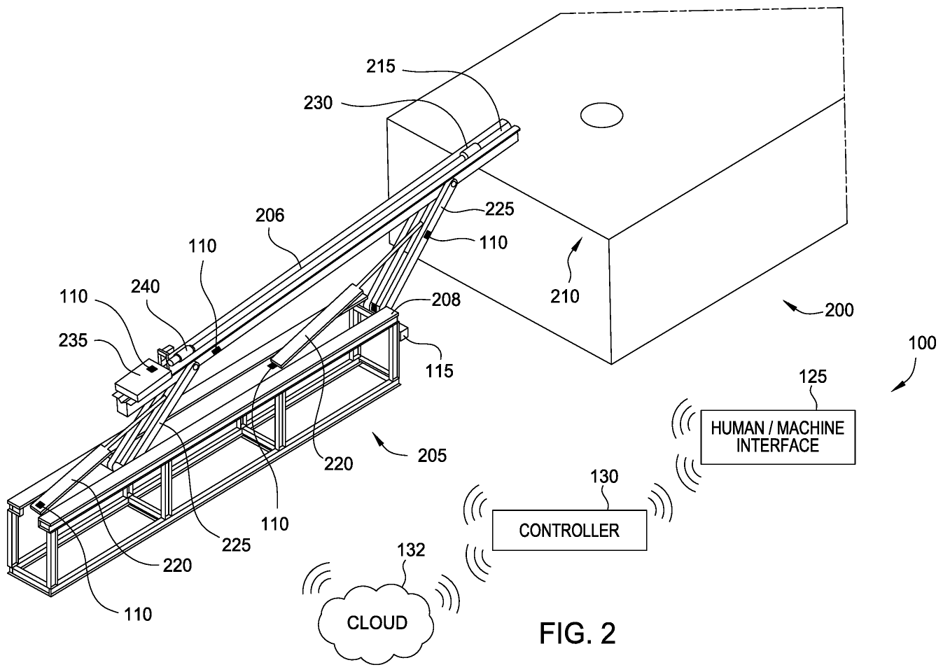

FIG. 2 is a schematic view of a catwalk 205 next to a rig 200 according to one embodiment. The catwalk 205 depicted in FIG. 2 is one example of the various types of drilling equipment that the embodiments disclosed herein can be used with to determine structural health utilizing the real-time performance monitoring and predictive maintenance system 100. The operational data of the catwalk 205 as measured by the operating sensors 110 is communicated to the onboard processing transceiver 115 to calculate the performance data as described herein and transmit the performance data to the human/machine interface 125, the controller 130, and/or the cloud based system 132.

The catwalk 205 is configured to convey a tubular 206 between a staging rack 208 and a rig floor 210. The catwalk 205 includes a trough 215 that is raised and lowered by one or more piston/cylinders 220 via one or more cross bars 225. The tubular 206 is conveyed along the trough 215 to and from the rig floor 210. The tubular 206 has a box end 230 that may be engaged by a lifting device, such as an elevator on the rig 200, to transfer the tubular 206 to and from the catwalk 205 and the rig floor 210. A skate 235 may engage a pin end 240 of the tubular 206 and push or pull the tubular 206 along the length of the trough 215 during transfer of the tubular 206.

The operating sensors 110 are coupled to various components of the catwalk 205. The operating sensors 110 are shown as being coupled to the trough 215, the piston/cylinders 220, the cross bars 225, and the skate 235, but can be coupled to other components of the catwalk 205. The operating sensors 110 are configured to measure the operation of the various components to gather operational data regarding the catwalk 205. The operating sensors 110 include but are not limited to one or both of a load sensor and a position sensor.

If the operating sensor 110 is a load sensor, the operating sensor 110 collects loading conditions of the catwalk 205. The load sensor may be a transducer configured to generate an electrical signal whose magnitude is directly proportional to the force being measured. Examples of the load sensor include load cells, load pins, pressure transducers, strain sensors, displacement sensors, electrical load sensors (e.g., amperage and/or voltage), temperature sensors, and/or vibration sensors (e.g., accelerometers and/or velocity sensors).

In one example, the operating sensors 110 are configured to determine the loading conditions on the catwalk 205 due to the weight of the tubular 206 by measuring the load on the trough 215 and/or the cross bars 225, as well as the pressure in the piston/cylinders 220. In one example, the operating sensors 110 are configured to determine the loading conditions on the catwalk 205 due to the weight of the tubular 205 by measuring the force needed to move the skate 235, which pushes or pulls the tubular 206 along the trough 215. In one example, the weight of the tubular 206 can be determined by measuring the pressure in the piston/cylinders 220 via the operating sensors 110 when the piston/cylinders 220 are in a known position.

If the operating sensor 110 is a position sensor, the operating sensor 110 is configured to measure boundary conditions, such as orientation, position, and/or angle data, of the catwalk 205. The position sensor may be a transducer configured to generate an electric signal whose magnitude is directly proportional to the change in position of a component being measured. The position sensor can be an absolute position sensor and/or a relative position sensor. The position sensor can be linear; angular, or multi-axis. Examples of position sensors include displacement sensors, angle encoders, linear variable differential transformers (LVDTs), inclinometers, proximity sensors, and/or potentiometers.

In one example, the operating sensors 110 are configured to determine boundary conditions of the catwalk 205 by measuring the angle of the cross bars 225.

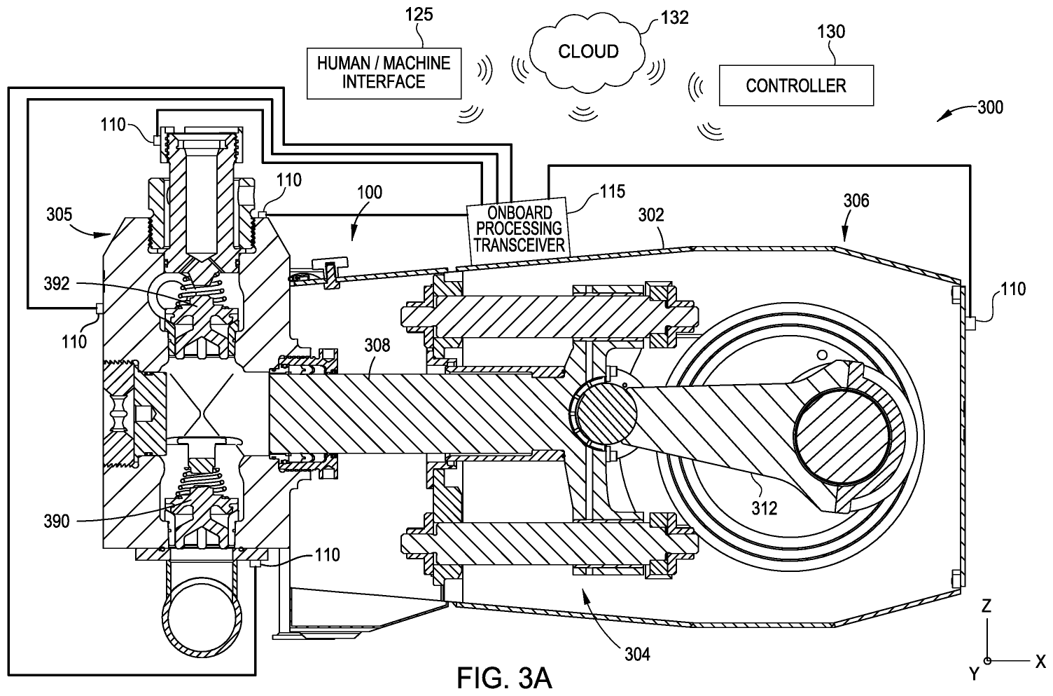

FIGS. 3A and 3B illustrate sectional views of a pump system 300 at different operating positions, according to one embodiment. The pump system 300 is shown in a fully retracted position in FIG. 3A and in a fully extended position in FIG. 3B. The pump system 300 depicted in FIGS. 3A and 3B is another example of the various types of drilling equipment that the embodiments disclosed herein can be used with to determine structural health utilizing the real-time performance monitoring and predictive maintenance system 100. The operational data of the pump system 300 as measured by the operating sensors 110 is communicated to the onboard processing transceiver 115 to calculate the performance data as described herein and transmit the performance data to the human/machine interface 125, the controller 130, and/or the cloud based system 132.

The pump system 300 includes a power end 306 coupled to a fluid end 305. The power end 306 includes a crankshaft 312 coupled to a plunger assembly 304 in a pump housing 302. The plunger assembly 304 further includes a plunger 308 that extends into the fluid end 305. The fluid end 305 includes a suction valve 390 and a discharge valve 392. In operation, the plunger 308 is movable by the crankshaft 312 between the fully retraced position shown in FIG. 3A to draw fluid into the fluid end 305 through the suction valve 390 and the fully extended position shown in FIG. 3B to force fluid out of the fluid end 305 through the discharge valve 392.

The operating sensors 110 are shown coupled to the fluid end 305 and the power end 306 but can be coupled to any component of the pump system 300. The operating sensors 110 are configured to measure the operating conditions of the power end 306 and the fluid end 305 to gather operational data. The operating sensors 110 are configured to transmit the operational data to the onboard processing transceiver 115 for processing as described herein.

In one example, the operating sensors 110 are configured to measure vibration of the fluid end 305 (such as by measuring the movement of the fluid end 305 using one or more accelerometers) during operation. In one example, the operating sensors 110 are configured to measure the position of the power end 306 using an angle encoder or a proximity sensor during operation. In one example, the operating sensors 110 are configured to determine the position of the plunger 308 by measuring the angle of the crankshaft 312.

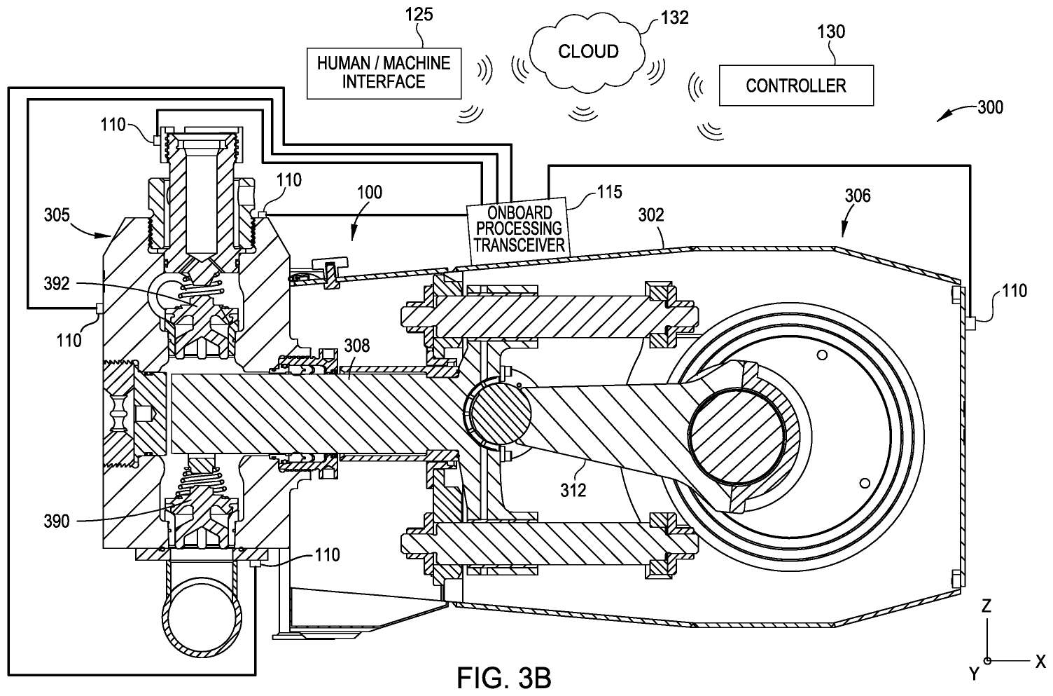

FIG. 4 is a flow chart depicting one embodiment of a method 400 for monitoring structural health of a piece of equipment, such as the piece of equipment 105 of FIG. 1, the catwalk 205 of FIG. 2, and/or the pump system 300 of FIGS. 3A and 3B.

At step 405, the onboard processing transceiver 115 receives operational data of the piece of equipment from the operating sensors 110. The operational data includes operational history, loading conditions, and/or boundary conditions. Operational history includes information on cycles of the equipment (e.g., number of cycles and/or weight per cycle) and/or operational hours of the equipment. Loading conditions include load, weight, stress, pressure, vibration, temperature, current, and/or voltage. Boundary conditions include orientation data, position data, and/or angle data. The operating sensors 110 measure and communicate the operational data regarding the piece of equipment in real time and continuously to the input/output unit 135 of the onboard processing transceiver 115 during operation of the piece of equipment.

Optionally, at step 408, the operational data may be stored on the memory unit 140 of the onboard processing transceiver 115.

At step 410, the first processing device 155 of the processor 145 of the onboard processing transceiver 115 calculates stress of the piece of equipment based on the operational data from step 405. The calculation may be performed by software containing an algorithm that calculates stress based on the operational data, including one or both of loading conditions and boundary conditions. In one example, stress may be calculated using a lower order model derived from prior analysis performed prior to real time sensing. The prior analysis may be a numerical analysis and/or finite element analysis. The stress data may be based on specific time periods, or intervals or increments of time, such as, for example, every 10 seconds. The calculated stress is output from the first processing device 155 as stress data and communicated to the second processing device 160 of the processor 145 of the onboard processing transceiver 115.

At step 415, the second processing device 160 calculates fatigue and/or cumulative damage of the piece of equipment based on the stress data from step 410. The calculation may be performed by software containing an algorithm that determines a delta between a maximum stress value and a minimum stress value from the stress data within predetermined time intervals, such every 10 seconds.

The delta stress value for every time interval is then used to calculate fatigue and/or cumulative damage. Fatigue and/or cumulative damage calculations assume that a stress cycle is beyond the endurance limit of the material of the piece of equipment to inflict damage but is below the yield strength of the material. Additionally, the fatigue and/or cumulative damage calculations assume that the total damage caused by several stress cycles is equal to the sum of all damage.

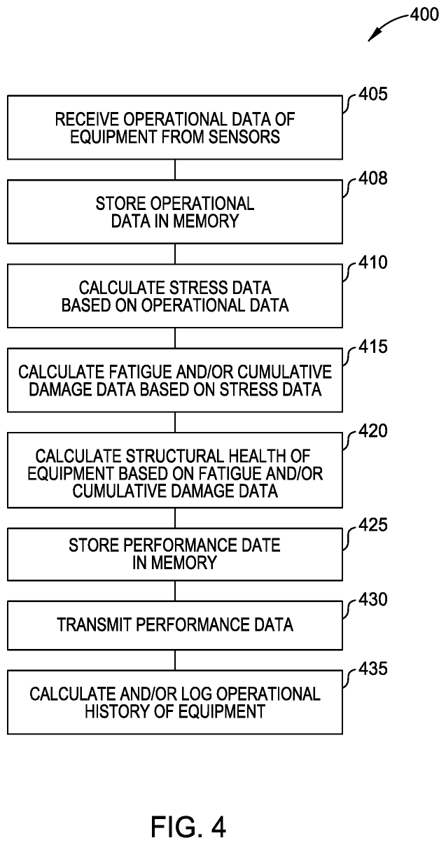

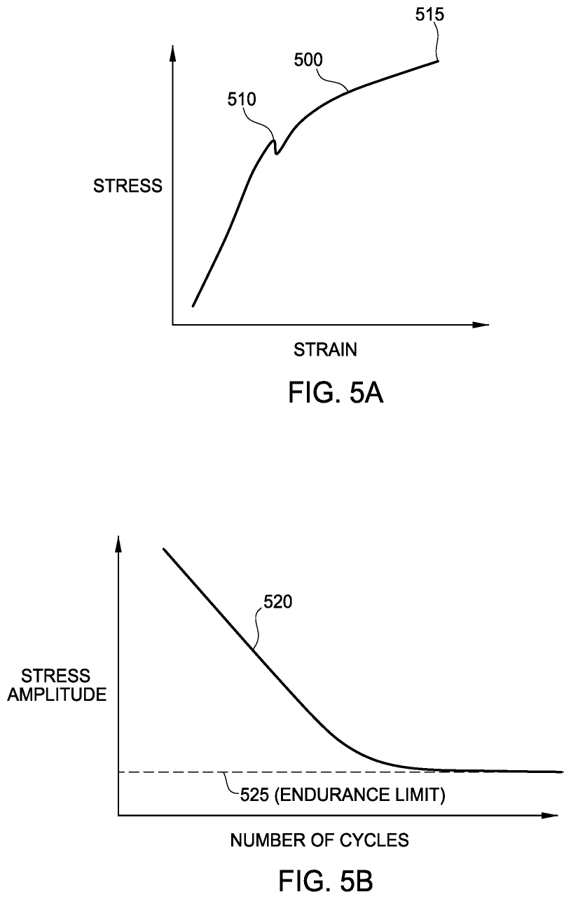

FIGS. 5A and 5B are graphs depicting a stress-strain curve and an endurance limit of a material of a piece of equipment, respectively. In FIG. 5A, the x-axis represents strain and the y-axis represents stress. A curve 500 is shown having a yield point 510 and an ultimate tensile strength point 515 of a material of the piece of equipment. In FIG. 5B, the x-axis represents number of stress cycles and the y-axis represents stress amplitude. A curve 520 shows the stress amplitude approaching an endurance limit (indicated by dashed line 525) as the number of stress cycles increases. The fatigue and/or cumulative damage calculations assume that during each stress cycle, the piece of equipment experiences stress that is above zero but below the yield point of the material. And as the number of stress cycles increases, the stress amplitude will decrease until the material reaches an endurance limit.

Referring again to FIG. 4, the calculated fatigue and/or cumulative damage is output from the second processing device 160 as fatigue data and/or cumulative damage data and communicated to the third processing device 165 of the processor 145 of the onboard processing transceiver 115.

At step 420, the third processing device 165 calculates structural health of the piece of equipment based on the fatigue data and/or cumulative damage data from step 415. The calculation may be performed by software containing an algorithm that determines structural health by comparing the fatigue data and/or cumulative damage data to traditional fatigue data and/or cumulative damage models corresponding to the piece of equipment. Calculated structural health may be determined as the remainder after all damage is accounted for.

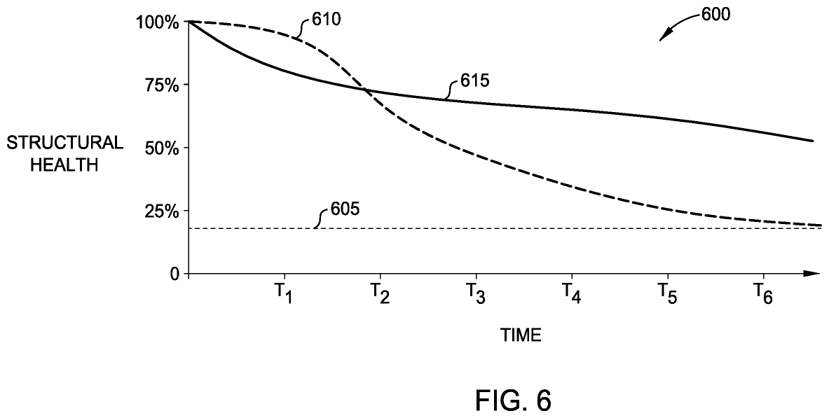

The calculated structural health can be output from the third processing device 165 as performance data in the form of a graph (as shown in FIG. 6) illustrating the structural health over time of the piece of equipment, which can be used to determine the remaining operating life of the piece of equipment.

Optionally, at step 425, the performance data may be stored on the memory unit 140 of the onboard processing transceiver 115.

At step 430, the performance data is communicated to the communication unit 150, which transmits the performance data (e.g. the stress, fatigue and/or cumulative damage, structural health data, and/or any other operational data) to the human/machine interface 125, the controller 130, and/or the cloud based system 132. The performance data can be communicated to the human/machine interface 125, the controller 130, and/or the cloud based system 132 via wireless communication at a frequency lower than the frequency that the operational data was communicated to the onboard processing transceiver 115.

At step 435, the human/machine interface 125, the controller 130, and/or the cloud based system 132 are configured to calculate and/or log the operational history of the piece of equipment. The human/machine interface 125, the controller 130, and/or the cloud based system 132 are also configured to identify trends within the operational history and/or the performance data to predict optimal equipment maintenance intervals. The cloud based system 132 may be used to gather operational history from a single piece of equipment data or from several pieces of equipment (e.g. an entire fleet of equipment), and compare the operational histories of all the pieces of equipment to identify trends and help predict optimal equipment maintenance intervals.

FIG. 6 is one example of a graph 600 illustrating a comparison of actual versus real time structural health over time of a piece of equipment as calculated by onboard processing transceiver 115. The y-axis represents structural health of the piece of equipment being monitored and the x-axis represents time (which may for example be in seconds, minutes, hours, days, weeks, months, or years). The structural health is divided into specific percentages with 100% representing a fully healthy piece of equipment and 0% representing a non-usable state of the piece of equipment.

Line 605 represents a percentage of structural health where preventative maintenance, or refurbishment, should be scheduled or performed. Line 610 represents a traditional structural health curve for a piece of equipment, such as the piece of equipment 105, the catwalk 305, and/or the pump system 300, when operated at specified operating conditions. Line 615 represents the actual structural health curve for the same piece of equipment during operation in real time as calculated by the real-time performance monitoring and predictive maintenance system 100.

At time T1 for example, the actual structural health of the piece of equipment is less than traditional structural health that the piece of equipment should be at if operated at the specified operating conditions. The difference may indicate that the piece of equipment has been operating above the specified operating conditions up until time T1.

At time T6 for example, the actual structural health of the piece of equipment is still above 50% and is greater than the traditional structural health for that same piece of equipment. The difference may indicate that the piece of equipment has been operating well below the specified operating conditions up until time T6. In addition, the actual structural health is well above line 605, which indicates the percentage of structural health where preventative maintenance, or refurbishment, should be scheduled or performed. Based on the graph 600, the preventative maintenance, or refurbishment, can be delayed for a longer period of time, which can delay cost or any downtime that would otherwise have been incurred if an operator was following the traditional structural health curve.

Using the real-time performance monitoring and predictive maintenance system 100, the operation of the piece of equipment 105 of FIG. 1, the catwalk 205 of FIG. 2, the pump system 300 of FIGS. 3A and 3B, and/or any other piece of equipment can be continuously monitored in real time to thereby increase safety, predict end of operating life, and optimize maintenance times, among other actions. The structural health acquired by monitoring the real time operation of the piece of equipment provides an operator with valuable insight into the performance of the equipment, for example, if the equipment is being operated above or below specified operating conditions, such as weight limits or number of cycles.

If the piece of equipment is being operated above (or below) specified operating conditions, then the operator can schedule inspection and/or maintenance sooner (or later) than a scheduled maintenance period. If the piece of equipment is being operated above (or below) specified operating conditions, then the operator can change the operation by lessening (or increasing) the loads, reducing (or increasing) cycle time, and/or adjusting any other operating condition to stay within specified operating conditions.

The real-time performance monitoring and predictive maintenance system 100 is configured to determine the remaining operating life and optimal maintenance intervals of a piece of equipment based on the structural health. For example, instead of performing maintenance dictated solely by a calendar, an operator may delay time-based scheduled maintenance if the equipment is being operated under specified operating conditions. Alternatively, if the equipment is being operated within or beyond the specified operating conditions, then maintenance cycles may be determined to occur sooner based on real time operational history, loading conditions, and/or boundary conditions associated with the equipment.

One advantage of the real-time performance monitoring and predictive maintenance system 100 includes collecting operational data about a piece of equipment in real time to more accurately predict the structural health and thus remaining operating life of the piece of equipment. Another advantage of the real-time performance monitoring and predictive maintenance system 100 includes using more robust mechanisms to measure operational data about a piece of equipment that can tolerate various environmental elements, such as vibration and lubricants, and still provide accurate results.

While the foregoing is directed to embodiments of the disclosure, other and further embodiments may be devised without departing from the basic scope thereof, and the scope thereof is determined by the claims that follow.

1. A system for monitoring structural health of a piece of equipment in real time, comprising:
a piece of equipment;
one or more operating sensors coupled to the piece of equipment, wherein the operating sensors are configured to measure operational data of the piece of equipment during operation; and
an onboard processing transceiver coupled to the piece of equipment and in communication with the operating sensors, wherein the onboard processing transceiver is configured to determine structural health of the piece of equipment.

2. The system of claim 1, wherein the onboard processing transceiver comprises a first processing device configured to calculate stress data based on the operational data.

3. The system of claim 2, wherein the onboard processing transceiver comprises a second processing device configured to calculate fatigue data and/or cumulative damage data based on the stress data.

4. The system of claim 3, wherein the onboard processing transceiver comprises a third processing device configured to calculate structural health of the piece of equipment based the fatigue data and/or cumulative damage data.

5. The system of claim 1, wherein the onboard processing transceiver is configured to receive the operational data at a first frequency, process the operational data to calculate performance data, and transmit the performance data at a second frequency that is lower than the first frequency.

6. The system of claim 5, wherein the onboard processing transceiver is configured to transmit the performance data at the second frequency to a human/machine interface, a controller, or a cloud based system.

7. The system of claim 5, wherein the performance data is output in the form of a graph indicating percentage of structural health over time.

8. The system of claim 1, wherein the operating sensors are wired to the onboard processing transceiver.

9. The system of claim 1, wherein the operational data includes operational history, loading conditions, and boundary conditions, wherein the operational history includes at least one of information on cycles of the equipment and operational hours of the equipment, wherein the loading conditions includes at least one of load, weight, stress, pressure, vibration, temperature, current, and voltage, and wherein the boundary conditions include at least one of orientation data, position data, and angle data.

10. The system of claim 1, wherein the onboard processing transceiver is dedicated to the piece of equipment such that the onboard processing transceiver travels with the piece of equipment.

11. A method for monitoring structural health of a piece of equipment in real time, comprising:
receiving operational data from one or more operating sensors that are coupled to the piece of equipment;
calculating stress data based on the operational data;
calculating fatigue data and/or cumulative damage data based on the stress data; and
calculating structural health based on the fatigue data and/or cumulative damage data to determine remaining operating life of the piece of equipment.

12. The method of claim 11, wherein the operational data includes operational history, loading conditions, and boundary conditions.

13. The method of claim 12, wherein the operational history includes at least one of information on cycles of the equipment and operational hours of the equipment.

14. The method of claim 12, wherein the loading conditions include at least one of load, weight, stress, pressure, vibration, temperature, current, and voltage.

15. The method of claim 12, wherein the boundary conditions include at least one of orientation data, position data, and angle data.

16. The method of claim 11, wherein the stress data, the fatigue data and/or cumulative damage data, and the structural health is calculated by an onboard processing transceiver coupled to the piece of equipment.

17. The method of claim 11, further comprising transmitting the stress data, the fatigue data and/or cumulative damage data, the structural health, and/or any other operational data in the form of performance data to at least one of a human/machine interface, a controller, and a cloud based system.

18. The method of claim 17, further comprising controlling the operation of the piece of equipment based at least in part on the performance data.

19. The method of claim 11, wherein the piece of equipment is a catwalk.

20. The method of claim 11, wherein the piece of equipment is a pump.
